(19) United States
(12) Patent Application Publication
(10) Pub. No.: US 2004/0156754 A1
(43) Pub. Date: Aug. 12, 2004

(54) Pipetting device and method for producing the same

(75) Inventors: Michaela Fritz, Munchen (DE); Stephan Dertinger, Munchen (DE); Karin Fuchs, Bach An Der Donau (DE); Thomas Haneder, Dachau (DE); Hans-Christian Hanke, Munchen (DE); Martin Jenkner, Planegg (DE); Volker Lehmann, Munchen (DE); Christian Paulus, Weilheim (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 10/745,473

(22) Filed: Dec. 22, 2003

Related U.S. Application Data
(63) Continuation of application No. PCT/EP02/06855, filed on Jun. 20, 2002.

(30) Foreign Application Priority Data
Jun. 22, 2001 (DE) 101 30 218.5

(51) Int. Cl. B01L 3/02

(52) U.S. Cl. 422/100

(57) ABSTRACT

An apparatus, in which at least one pipette in the form of a through-hole with a predetermined diameter is formed in a substrate, with a rim of the through-hole projecting by a predetermined amount from an adjacent surface of the substrate.

### CROSS-REFERENCE TO RELATED APPLICATIONS

This application is a continuation of International Patent Application Serial No. PCT/EP02/06855, filed Jun. 20, 2002, which published in German on Jan. 3, 2003 as WO 03/000421 A1.

### FIELD OF THE INVENTION

The invention relates to an apparatus, in particular for patch clamping of vesicles and/or for dispensing of small, defined amounts of liquid on surfaces, and to a method for formation of at least one pipette in a substrate.

### BACKGROUND OF THE INVENTION

Particularly in the field of modem biotechnology, the manipulation of very small amounts of liquid in the picoliter to nanoliter range is of central importance. By way of example, the parallel dispensing of defined amounts of liquid in this volume range is a fundamental step in the production of so-called biochips. By analogy with the ongoing efforts in semiconductor technology to reduce the structure sizes of electronic semiconductor components, attempts are equally being made to increase the information density (spot density) on biochips. This will allow the throughput of assays which can be carried out with the biochips to be increased, which is associated in particular with a cost reduction. In order to make it possible to produce high-density arrays at low cost and quickly in large quantities, so-called printing heads are required which can print a large number (in particular ≧96 spots) per “printing step” in parallel. Printing heads such as these must therefore be designed to make it possible to apply a large number of well-defined, very small amounts of liquid in parallel with high positioning accuracy at predetermined spot positions and reproducibly on a surface. In this case, the spot separations are typically in ranges between 10 μm and 1000 μm. In addition to high spot densities and very small but precisely defined dispensation amounts, a high degree of uniformity and reproducibility of the printing process are required over the substrate. The printing heads which are known from the prior art satisfy this requirement profile only to a limited extent.

The invention can furthermore advantageously be used for the patch clamp technique, which was invented by Neher and Sackmann, and which has been among the central laboratory methods in many fields of cell biology for many years. The patch clamp technique provides a relatively large access, and at the same time well-sealed access, to a vesicle or to a cell and, on the one hand, this allows the composition of the cytoplasm to be manipulated while, on the other hand, representing a low-impedance electrical access with very little leakage conductivity. A patch clamp provides an extremely well-sealed connection between the annular tip of a glass micropipette and a cell membrane. The seal is characterized by the electrical resistance of the annular contact. This resistance is preferably in the Gigaohm range, that is to say a so-called “Giga seal” is provided.

The patch pipettes which are used for patch clamping are produced from a small glass tube that is subjected to mechanical tension and heat. This process is relatively complex and difficult to monitor. Furthermore, the handling of such individual patch pipettes is highly complex, since a positioning accuracy and holding accuracy in the sub-micron range must be achieved. Very complex micromanipulators are required for this purpose, which have a high degree of stiffness and must be designed and mounted such that extremely little vibration is produced. Systems such as these are on the one hand very expensive and, furthermore, are also very large, so that no more than three or four pipettes can be used at the same time.

A further problem is the stray capacitance of the pipette, whose wall has a thickness of approximately 200 nm to 300 nm in the region of the tip. In order to keep the stray capacitance or parasitic capacitance of the pipette wall as small as possible, the wall thickness of a patch pipette is thus frequently increased by manual application of silicone virtually as far as the tip.

### SUMMARY OF THE INVENTION

One object of the invention is thus to provide an apparatus in particular for patch clamping of vesicles with an extremely low-impedance access to the vesicle, or for dispensing of small, defined amounts of liquid onto surfaces, as well as a method for production of such an apparatus.

This object is achieved by an apparatus and method defined in the claims.

The apparatus according to the invention is particularly suitable for patch clamping of vesicles. In this case, the expression vesicles means objects, in particular biological objects comprising a closed lipid membrane, which can be handled in the liquid phase, preferably water. In general, these are particles which comprise a lipid membrane with at least one lipid layer. Examples of vesicles such as these are cells, in particular nerve cells, genetically manipulated cells with voltage-dependent ion channels, giant cells fused from erythrocytes or spheres composed of lipid double layers.

The apparatus according to the invention is also suitable for well-defined, reproducible application (“printing”) of very small amounts of liquid in the picoliter to nanoliter range onto a surface. A “printing process” such as this is a central process in particular for the production of biochips.

In the apparatus according to the invention, at least one pipette in the form of a through-hole with a predetermined diameter is formed in a substrate, with a rim of the through-hole projecting by a predetermined extent from an adjacent surface of the substrate. This projecting rim forms a pipette tip in a similar manner to the tip of a conventional patch pipette. A pipette tip configured in this way makes it possible to produce a “Giga seal”, that is to say a sealed, low-impedance access to a vesicle or to a cell, whose sealing resistance, that is to say the resistance to the exterior, is in the Gigaohm range.

The pipette with the projecting rim can furthermore also be in the form of a printing needle, nozzle or capillary, particularly one that is split, so that the apparatus according to the invention is suitable for use as a “printing head”. The rim may be designed to match the desired geometric shape of the pipette tip, so that, in particular, optimum patch clamping and/or optimum liquid transfer characteristics can be achieved on it and/or with it. The diameter of the through-hole in the region of the rim which forms the pipette tip is preferably in the range from 0.5 to 20 μm, and furthermore preferably 1 to 2 μm.

The arrangement of a pipette such as this in a substrate or mount allows a high degree of mechanical robustness, so that there is no need for complex micromanipulators. The substrate is preferably planar or flat. For patch clamping, the individual vesicles or cells are placed thereon in the region of the pipette tip or of the rim. For this purpose, positioning aids for vesicles may additionally be arranged on the substrate surface, so that a vesicle can be positioned such that it is aligned accurately on the pipette tip. The through-hole, that is to say the pipette, can be formed at a precisely defined position in the substrate, thus allowing subsequent arrangement of a vesicle very easily and automatically.

When using the apparatus according to the invention as a printing head, the constriction behavior or tearing-off behavior of the liquid droplets to be dispensed by the pipette can be controlled via the special geometry of the projecting rims. The shape of these rims can be varied freely within wide ranges. In particular, tapering, straight or funnel-shaped rim geometries are possible. Exact matching of the pipette shape to the desired constriction or tearing-off behavior can be achieved via such rim geometries and the further geometric characteristics of the pipette on its rim or opening area, in particular the rim thickness, the rim height and the local rim curvature. In particular, the opening geometry of the pipette may be designed to be round, rectangular or in the form of a slot in a section surface running at right angles to the pipette's longitudinal axis. The inclination angle (opening angle) of the projecting walls or rims can likewise be varied in a wide range. This makes it possible to achieve a high degree of uniformity for the printing or dispensing process with an apparatus according to the invention over the substrate to be printed on, allowing reproducibly very small dispensing amounts to be set, in the picoliter to nanoliter range.

At least the rim is preferably composed of at least a different material rfom the substrate, and is preferably composed of SiO₂ or Si₃N₄. Furthermore, the rim may also have Ta₂O₅, HfO₂, Y₂O₃, Al₂O₃, Nb₂O₅, TiO₂, TaO₂ and/or a nitride or oxynitride of Al, Si or Hf.

For use of the apparatus according to the invention as a patch clamp for vesicles, the rim can preferably be formed from a material which is essentially similar to that of a conventional patch pipette composed of glass, in order to ensure similarly good sealing characteristics to those of a vesicle membrane. In this case, the material of the rim, that is to say of the pipette tip which makes contact with a vesicle, can be chosen to be essentially independent of the material of the substrate. The material of the substrate can be chosen on the basis of mechanical viewpoints, in order to achieve an apparatus which is as robust and stiff as possible. The thickness of the rim is preferably in the range from 200 to 300 nm, and thus corresponds in particular to the wall thickness of conventional patch pipettes.

Furthermore, an inner wall of the through-hole is preferably at least partially composed of a different material from the substrate, and preferably of SiO₂ or Si₃N₄. Furthermore, the inner wall may also have Ta₂O₅, HfO₂, Y₂O₃, Al₂O₃, Nb₂O₅, TiO₂, TaO₂ and/or a nitride or oxynitride of Al, Si or Hf. In particular, in a situation such as this, the inner wall of the through-hole may be formed integrally from the same material as the rim. A refinement such as this essentially forms a pipette which is integrated in a substrate and has an inner surface with desired material characteristics. The coating on or the material of the inner wall of the through-hole may, in particular, be selected in accordance with electrical requirements, in order to ensure as low a stray capacitance as possible for the pipette for a patch clamp. The thickness of the coating can be set as required, but is preferably in the range from 200 to 300 nm.

The inner face of the rim and preferably the inner face of the through-hole may preferably be composed of a different material from the outer face of the rim. With an arrangement such as this, the rim is thus formed at least in two layers, so that the characteristics of the pipette outer face can be set independently of the characteristics of the pipette inner wall. Since the inner wall of the through-hole is preferably composed of the same material as the rim, that is to say it is formed integrally with it, the inner wall of the through-hole may preferably also be formed correspondingly at least from two different material layers. In this case, the first material layer faces the substrate, and the second material layer forms the actual pipette inner wall.

At least one layer composed of an electrically conductive material is preferably formed on the rim and/or on the inner wall of the through-hole. The rim and the coating on the inner wall of the through-hole are preferably in this case formed in three layers. In this case, by way of example, the two outer layers, that is to say the layer facing the hole and the layer facing the substrate, have electrically insulating characteristics, while the central layer is of an electrically conductive nature. This central layer may, for example, be vapor-deposited from a metal such as aluminum or ITO (indium tin oxide). This makes it possible to provide further electrical shielding for the pipette hole independently of the substrate, which improves the crosstalk and shielding behavior of the respective pipette for example in the form of a “driven shield”, which is advantageous for use of the apparatus for patch clamping.

A distal end of the rim is preferably rounded. The distal end is the outer end of the rim, which forms the pipette tip. The rounding may be in a similar form to a conventional glass pipette. However, it is also possible to define the shape of the rim, that is to say of the pipette tip, freely in order in particular to ensure an optimum connection to a vesicle or cell membrane and to achieve an optimum liquid transfer behavior for the printing head.

Furthermore, the through-hole preferably tapers towards a distal end of the rim. This results in a pipette shape which essentially corresponds to the shape of a conventional patch pipette and is thus particularly suitable for patch clamping of vesicles. In the area of the pipette tip, that is to say at the distal end of the rim, the through-hole preferably has a diameter of 0.5 to 20 μm, and preferably 1 to 2 μm. A pipette shape in which the through-hole widens or opens towards a distal end of the rim may likewise be advantageous.

The substrate is preferably composed of a material which includes silicon. Very thin holes can easily be formed at predetermined points in silicon by photolithographic means. A method such as this for formation of holes with a small diameter in silicon is known from WO 99/58746. However, other materials, in particular semiconductor materials as well as their doped modifications such as germanium or GaAs, may also be used instead of silicon. In particular, these materials should be suitable for processing using the method cited in WO 99/58746, that is to say it should be possible to structure them photolithographically and to process them using anisotropic etching methods. Reference is made to the entire production method as described in WO 99/58746 so that, to this extent, WO 99/58746 should be regarded as part of the overall disclosure of the present application.

Two or more pipettes are preferably formed in the substrate and are preferably arranged in the form of a grid or matrix in the substrate. A large number of individual pipettes can be arranged in a common mount or substrate in an arrangement such as this. Less than 400 pipettes per mm² are preferably used when the apparatus according to the invention is used for patch clamping. More than four and less than 2500 pipettes per mm² are preferably provided when it is used as a printing head. The substrate is in this case preferably in the form of a planar mount, for example in the form of a silicon wafer or chip. The joint arrangement of a large number of pipettes in a common mount makes it possible to achieve a very simple arrangement of the pipettes with a high degree of robustness and stiffness. It is thus possible to use considerably more pipettes at the same time than was possible, in particular, with conventional glass pipettes.

The distances between adjacent pipettes can be set reproducibly, by means of photolithographic definition, in a range between 5 μm and 500 μm, preferably between 10 μm and 200 μm.

Furthermore, there is no need to use any manipulation devices, which are complex to mount or are vapor-deposited, for the pipettes when the apparatus is used for patch clamping. Since the pipettes can be formed at precisely defined positions in the substrate, vesicles and cells can very easily be arranged at these predetermined positions on the pipette tips. Positioning aids may additionally be formed on the substrate for this purpose, or may be fitted to it. An apparatus refined in this way makes it very simple to carry out patch clamping on a large number of vesicles at the same time.

The method according to the invention for forming at least one pipette in a substrate has at least the following steps. First of all, a hole is formed in the substrate. A changed surface layer is then formed on at least the inner surfaces of the hole. After this, the substrate is removed selectively, with the changed surface layer essentially not being attacked, so that it projects above the surface of the substrate and forms a projecting rim. In one suitable method step, the hole is formed as a through-hole in the course of the method. This creates an integrated pipette in the substrate, with the projecting rim forming the pipette tip. Individual pipettes with a predetermined hole diameter can be created by this method at precisely defined positions in a preferably planar surface of a substrate. This allows a large number of pipettes to be formed in the substrate at the same time.

It is very simple to produce an apparatus which has a large number of pipettes, in particular for patch clamping of a large number of vesicles or cells or for simultaneous reproducible dispensing of very small, accurately defined amounts of liquid. The method according to the invention allows the geometry of the holes and, in particular, of the projecting rims to be set very accurately. It is thus possible to produce a rim with a precisely defined thickness, by setting the thickness of the changed surface layer appropriately. The thickness of the changed surface layer and hence of the rim may, in particular, be set to about 200 to 300 nm, in order to match the wall thickness of the tips of conventional patch pipettes. The intensity of the selective removal of the substrate furthermore makes it possible to precisely set the height by which the rim projects above the adjacent surface of the substrate. The diameter and the shape of the hole can also be matched to desired purposes. The diameter of the hole at least in the area of the projecting rim is preferably 0.5 to 20 μm, and furthermore preferably 1 to 2 μm, and may thus in particular be chosen to be similar to the tips of conventional patch pipettes composed of glass.

The hole preferably tapers toward the face on which the rim is formed. This means that the hole essentially has the same shape as a conventional patch pipette, with the rim forming the pipette tip. In this way, the pipette which is formed in the substrate may have essentially the same characteristics as a conventional patch pipette, that is to say an extremely well-sealed and low-impedance access to a vesicle. The advantages mentioned above are, however, achieved in this case owing to the arrangement of the pipette in the substrate. The rim may also likewise be shaped such that it widens in particular in a funnel shape in the direction of the pipette opening.

The hole is preferably first of all formed as a blind hole. The use of a blind hole allows very accurate definition of the shape of the hole and of the pipette tip. The shape of the base of the blind hole thus subsequently defines the shape of the pipette tip. Since the shape of the blind hole can be varied very easily, it is also possible to vary the geometry of the pipette tip very easily in this way.

In a further preferred method step, once the blind hole has been formed, that face which is opposite an opening of the blind hole is removed as far as the base of the blind hole, so that the blind hole is opened in order to form a through-hole. In this case, the opening which is created by removal of the substrate at the base of the blind hole later forms the opening that is formed in the pipette tip. Since the geometry of the blind hole and the extent to which the substrate is removed can be varied within wide limits, these method steps allow the shape of the pipette tip to be varied in many ways. Since the method or the process can be controlled or regulated very reliably, this also results in a high degree of process reliability, which ensures good reproducibility of the predetermined shape of the pipette tip, that is to say of the blind hole and of the substrate removal.

The blind hole preferably tapers toward its base. This results in the blind hole having essentially the same shape as the tip of a conventional patch pipette. A sufficiently small opening with a diameter of preferably 1 to 2 μm can be created later at the tip of the pipette, that is to say at the base of the blind hole. The pipette produced in this way tapers towards its opening.

The blind hole is furthermore preferably formed by etching. In this case, the position of the blind hole can be defined by means of a photolithographic method. This also allows a large number of blind holes to be formed very easily at the same time in the substrate.

That face of the substrate which is opposite the opening of the blind hole is preferably removed by chemical and/or mechanical erosion. This method may comprise chemical/mechanical polishing (CMP). A method such as this allows a defined thickness to be removed from the substrate, in order to create a pipette tip with a precisely defined shape and a predetermined opening diameter.

Furthermore, the edges of the projecting rim are preferably rounded after the selective erosion. This may be done, for example, by etching. This results in the shape of the rim, that is to say of the pipette tip, corresponding to that of conventional patch pipettes. In particular, similar characteristics to those of a conventional patch pipette can thus be ensured, in particular the suitability for a “Giga seal” with a vesicle membrane.

The changed surface layer can additionally be formed on a surface of the substrate. This makes it possible to ensure that, during the selective erosion process, the only surface of the substrate which is removed is that on which the projecting rim, that is to say the pipette tip, is intended to be formed. The opposite face of the substrate is protected by the changed surface layer during the selective erosion process, and is thus not removed.

The changed surface layer may alternatively be formed over the entire surface of the substrate, and may be removed, preferably chemically and/or mechanically, before the selective erosion process on that face of the substrate on which the rim is formed. This removal process can be carried out at the same time as the removal of the substrate in order to open the blind hole. This allows the production method to be simplified, since the changed surface layer is first of all formed over the entire surface of the substrate and is then removed again, preferably together with a part of the substrate located underneath it, on the face on which the selective erosion is intended to be carried out. This step advantageously does not form an additional method step, since the substrate has to be removed in any case, in order to open the blind hole.

The selective removal of the substrate is preferably carried out by etching, with an etching agent being used which essentially does not attack the changed surface layer. This means that the changed surface layer is composed of a different material from the substrate. The etching agent then removes only the substrate, but not the changed surface layer. The changed surface layer thus remains after the removal of the substrate, is formed on the inner face of the hole, and projects beyond the surface of the substrate on the face on which the substrate has been removed. The changed surface layer then forms a projecting rim, which is used as a pipette tip. The depth of the substrate removal can be set very accurately by the duration of the etching process, so that the height of the projecting rim can likewise be defined accurately.

The substrate is preferably composed of a material which comprises a semiconductor material and, in particular, silicon. The required small holes can be formed very easily in a semiconductor material and, in particular, in silicon. One method for forming holes such as these with a small diameter in silicon is known from WO 99/58746. Furthermore, a semiconductor material and, in particular, silicon allows electrically active structures to be formed on the substrate itself. Structures such as these are preferably formed on that surface of the substrate which is opposite the rim or the pipette tip. Furthermore, the substrate material can also be used, for matching circuitry, as a heating element for controlled desorption of contaminating impurities on the rim or the rims of the pipette tips.

Furthermore, at least the changed surface layer is preferably produced by coating and/or modification of the surface of the substrate, in particular oxidation or nitriding. The surface layer may be applied in the form of a coating to the substrate material. In this case, a coating material is preferably used which has a similar composition to that of glass or quartz glass, from which patch pipettes are conventionally manufactured. Instead of having to coat the surface, it is also possible to modify or chemically change an upper layer or surface layer of the substrate. This may be done by reaction with various substances. For example, oxidation or nitriding can be carried out in an oxygen or nitrogen atmosphere, respectively. If the substrate material is silicon, a changed surface layer composed of SiO₂ or Si₃N₄ can be created very easily by oxidation or nitriding.

The changed surface layer may have two or more layers, preferably composed of different materials, at least in places and at least in the area of the hole. For this purpose, for example, two layers composed of different materials may be applied to the substrate successively. Alternatively, it is feasible to create the first layer by modification of a surface layer of the substrate, for example by oxidation or nitriding, and then to apply a second layer by coating. Conversely, it is also feasible to apply a layer by coating first of all, and then to modify a surface layer of the applied material layer, for example by oxidation or nitriding. A two-layer configuration of the changed surface layer means that, once the substrate has been selectively removed, the projecting rim is formed in two layers and, in particular, has an outer face which is composed of a different material from the inner face. The rim or the pipette tip can thus be optimally matched to a desired purpose. The layer which forms the inner wall of the rim preferably extends further through the hole and forms the inner wall of the hole, so that the pipette that is formed in the substrate has a homogeneous continuous material layer on its inner face. This material is chosen in particular so as to make it possible to keep any stray capacitance of the pipette as small as possible. In addition, it is possible to form an electrically conductive layer, for example by vapor-deposition of a metal such as aluminum or ITO (indium tin oxide). If a conductive layer such as this is provided, a three-layer configuration of the changed surface layer is preferable, in which the electrically conductive layer is formed between two electrically insulating layers.

### BRIEF DESCRIPTION OF THE DRAWINGS

The invention will be described in the following text using the attached figures by way of example.

FIGS. 1A through 1F show, schematically, the procedure for one preferred variant of the method according to the invention for production of one preferred embodiment of the apparatus according to the invention.

FIGS. 2A through 2F shows the process procedure for a further variant of the method according to the invention.

FIGS. 3A through 3F shows the process procedure for a further variant of the method according to the invention.

### DETAILED DESCRIPTION OF THE PREFERRED MODE OF THE INVENTION

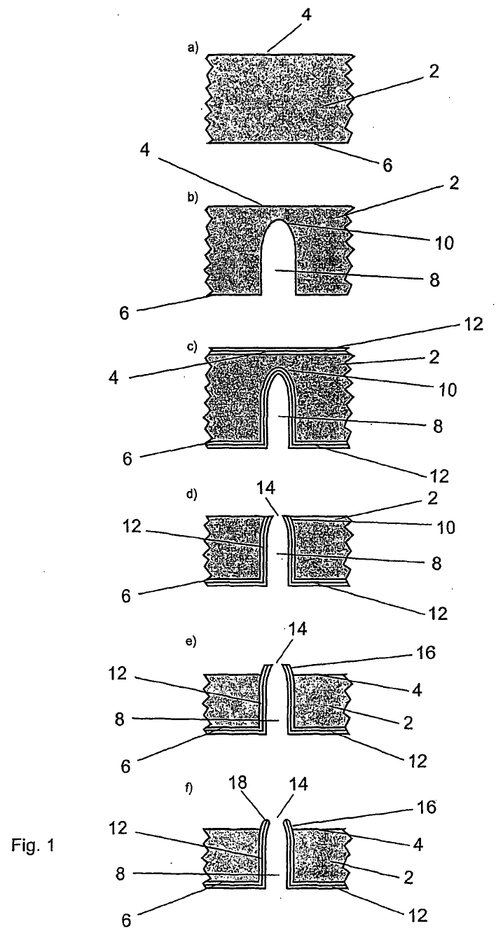

FIG. 1A shows, schematically and in the form of a section, a part of a mount or of a substrate 2. The substrate 2 is essentially in the form of a wafer with two mutually opposite surfaces 4, 6, which are essentially parallel to one another. The substrate 2 is preferably composed of silicon, although it may also be manufactured from other materials, in particular semiconductor materials.

As is illustrated in FIG. 1B, a blind hole 8 is formed in the substrate 2, starting from the surface 6. The blind hole 8 may be formed, for example, by means of a method according to WO 99/58746. The etching method, which is also referred to as electrochemical pore etching, is also described in detail in EP 0 296 348 A, EP 0 645 621 A, WO 99/25026, EP 0 553 465 A, and DE 198 20 756, which are incorporated herein by reference in their entirety. Starting from the surface 6, the blind hole extends essentially at right angles to this surface 6 in the direction of the surface 4. The blind hole 8 has a base 10 which is at a distance from the surface 4 in the interior of the substrate 2. The blind hole 8 tapers toward the base 10. The blind hole 8 and, in particular, the area which tapers toward the base 10 in this case essentially has the same shape as a pipette tip that is to be produced. The shape of the pipette tip that is to be produced can thus be defined by the shape of the blind hole 8. The electrochemical pore etching method allows pores or blind holes to be etched with an extremely high aspect ratio (the ratio of the blind hole diameter to its depth). For example, aspect ratios of 1:100 or more can be achieved in regular arrangements in silicon. The diameter of the blind holes is preferably in the range from 0.5 to 20 μm, in particular from 1 to 2 μm, and the distance (pitch) between the longitudinal center axes of the blind holes is preferably 10 μm to several hundred μm. The depth of the blind holes may be in the range from about 100 to 5000 μm, which covers typical semiconductor wafer thicknesses.

As is shown in FIG. 1C, the substrate 2 is provided in a next step with a changed surface layer 12. In the illustrated example, the changed surface layer 12 is formed both on the inner walls of the blind hole 8 and on the surfaces 4 and 6. The formation in the blind hole 8, a change to the surface layers on the surfaces 4 and 6, is not absolutely essential but is advantageous in terms of the method. In the illustrated example, the surface layer 12 is formed in two layers, that is to say it comprises two layers located one on top of the other. However, alternatively, a single-layer configuration or a configuration with more than two layers is also feasible. In the case of a silicon substrate 2, the changed surface layer 12 is preferably formed by oxidation or nitriding, thus resulting in a layer composed of SiO₂ or Si₃N₄. However, other layers may also be produced by modification of a surface layer of the substrate 2 or by application of coating materials. The surface layer 12 is composed of a material which has the material characteristics that are desired for a pipette, and is advantageously formed from a material similar to the glass of a known patch pipette. Since the surface layer 12 is formed over the entire surface of the substrate 2, that is to say over the surfaces 4, 6 and over the inner walls of the blind hole 8, the coating or surface modification can be carried out very easily, since the entire substrate can be oxidized, nitrided or coated in an appropriate atmosphere.

FIG. 1D shows the next method step, in which the surface layer 12 and a part of the substrate 2 on the surface 4 of the substrate 2 are removed. In the process, the substrate is removed until the base 10 of the blind hole 8 is opened. The opening 14 that is formed in this way later forms the opening at the pipette tip. For this reason, the substrate 2 and the surface layer 12 are removed precisely until an opening 14 with the desired size is formed in the base 10. The diameter of the opening 14 is preferably 1 to 2 μm. The removal process is preferably carried out by chemical/mechanical polishing (CMP), but may also be carried out by any other suitable removal method. The important factor in this case is for the removal to be carried out very precisely, in order to make it possible to set the desired size of the opening 14 accurately.

The next method step is illustrated in FIG. 1E, in which the substrate 2 is removed selectively. This is preferably done by etching, using an etching agent which removes only the substrate 2, but not the surface layer 12 that is used. Only the substrate 2 is thus removed, in particular on the surface 4, so that the part of the surface layer 12 in the vicinity of the base 10 of the original blind hole 8 forms a rim 16. This rim 16, composed of the surface layer 12, projects beyond the surface 4 of the substrate 2 and forms a pipette tip. The opening 14 is formed as a pipette opening in this pipette tip or in this rim 16. Since the surface layer 12 is formed on the surface 6 of the substrate 2, the surface 6 is not removed during the selective removal process. The amount of the substrate 2 which is removed can be influenced by the strength and duration of the removal process, that is to say preferably of the etching process. In consequence, the height by which the rim or the pipette tip 16 projects from the surface 4 can be set precisely. The removal of the substrate 2 on the surface 4 is in this case carried out at least in the vicinity of the blind hole or hole 8, in order to form a projecting rim 16 which defines a pipette tip.

In a final major method step, as is shown in FIG. 1F, the edges at a distal end 18 of the rim 16 can be rounded in order to produce the final geometry of the pipette tip 16. This rounding of the edges along the opening 14 can be carried out by means of a further short etching step.

After completion of this method, a pipette tip 16 is created on the surface 4 of the substrate 2 and can be formed such that it essentially corresponds to a conventional patch pipette and represents a printing channel for reproducible dispensing of very small amounts of liquid onto a surface. In contrast to known apparatuses, the preferred arrangement according to the invention has the advantage, however, that the pipette tip 16 is held firmly and fixed in the substrate 2. This allows a large number of pipette tips 16 to be formed at the same time and very easily in the described manner in the substrate 2. These pipette tips 16 are preferably arranged in a predetermined grid or matrix.

When the apparatus is being used for patch clamping, vesicles to be processed or to be patched can be placed on the substrate 2 using the same grid. Further positioning aids may be provided on the substrate 2 for this purpose, and it is possible to use additional positioning devices, in order to place the vesicle onto the pipette tips 16.

When the apparatus according to the invention is used as a “printing head”, the above production method allows the formation of pipette arrays (that is to say printing needle or printing nozzle arrays) with short distances between the dispensing channels. This allows not only a large number of spots but also high spot densities to be achieved at the same time in a printing process. The preferred monolithic bulge of the printing head and the embedding of the pipettes or capillaries in, preferably, silicon increases its mechanical robustness. There is no need for any retrospective adjustment of the pipettes or printing nozzles with respect to one another.

The hole 8 which is produced from the blind hole 8 is completely lined on its inner face with the material which forms the pipette tip 16. This allows the entire end area of a patch pipette to be made available in the substrate 2. The arrangement of the pipette in the substrate 2 also minimizes any stray capacitance in the area of the pipette wall, that is to say in this case of the surface layer 12.

In the illustrated example, the surface layer 12 is formed from two layers. This means that the pipette tip 16 has a different material on its outer face from that on its inner face, that is to say in the interior of the hole 8. However, alternatively, the surface layer 12 may also be formed from one layer or a number of layers. Furthermore, it is not absolutely essential for the surface layer 12 to be formed over the entire inner surface of the hole 8 and on the surface 6. For example, it will be possible to provide only that part of the hole 8 which faces the rim 16 with the surface layer 12. The surface layer is preferably composed of SiO₂, since silicon oxide or silicon dioxide is very similar to the quartz glass that is used in conventional patch pipettes.

Only the fundamental principles of the method according to the invention have been described here, and the method may, however, be modified or extended in many ways. For example, instead of a blind hole as is shown in FIG. 1B, it is equally possible to form a through-hole similar to the hole that is shown in FIG. 1D. Furthermore, it is possible to dispense with the surface layer 12 on the surface 4. In the situation where the hole is at the same time formed as a through-hole, it may be possible to dispense with the first removal process and just to carry out the step of selective etching. In addition, the method can be combined with a previous KOH etching process, which widens the lower opening in the hole, that is to say the opening opposite the rim 16, in order to reduce the access resistance to the pipettes that are formed.

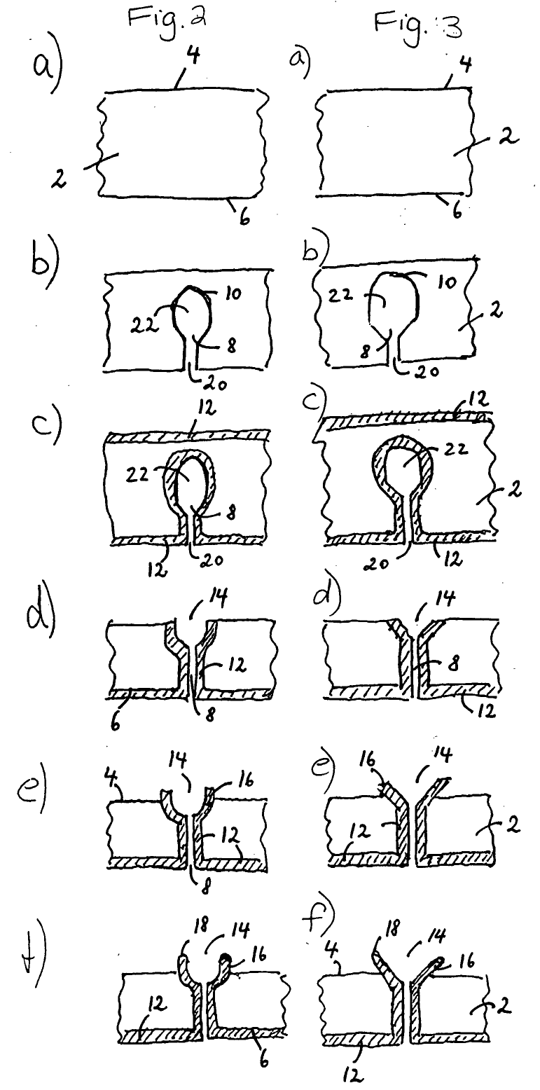

FIGS. 2A to 2F and FIGS. 3A to 3F show two further preferred variants of a production method according to the invention in the process procedure. Except for the differences that are described in the following text, the process steps in FIGS. 2A to 2F and FIGS. 3A to 3F correspond to those in FIGS. 1A to 1F, with the same reference symbols denoting the same features of the apparatus. These will therefore not be described again.

In the variant that is illustrated in FIGS. 2 and 3, the blind hole 8 is produced in the form of a bubble in the substrate 2 by suitable control of the electrochemical pore etching process. Starting from the surface 6, the blind hole 8 thus initially has a relatively small diameter, for example in the range from 0.5 μm to a few μm. This area 20 of the blind hole 8 that is close to the surface is followed in the direction of right angles to the surface 6 by an area 22 in the form of a bubble, which has a larger internal diameter. For example, the internal diameter of the area 22 that is in the form of a bubble may be several μm up to 100 μm.

The step of removal of the substrate 2 starting from the surface 4 is controlled such that the substrate 2 is removed only as far as that area 22 of the blind hole 8 that is in the form of a bubble. Since the inner walls of the blind hole 8 widen in a section that faces the surface 6 of the area 22 that is in the form of a bubble, this results in a pipette opening 14 whose opening diameter increases towards the distal end of the rim 16. As is illustrated in FIGS. 2D and 3D, this allows pipette tips 16 to be formed with a cup-shaped geometry (FIG. 2) or with a funnel-shaped geometry (FIG. 3).

The apparatuses according to the invention are likewise suitable for supplying synthesis substances as well as light for spatially limited, light-controlled synthesis of molecules. With regard to the fundamental method of operation of light-controlled synthesis of planar substrates, reference should be made to EP 0 619 321 and EP 0 476 014, which disclose the formation and light-controlled synthesis method, and which are incorporated herein by reference in their entirety. The pipettes of the apparatuses according to the invention can be used as optical waveguides for selective, local illumination of a substrate. The choice of silicon as the embedding material results in the individual pipettes being optically isolated from one another, and they can be used separately and independently of one another for passing light through. The local illumination that is thus possible allows light-induced chemical synthesis to be carried out in a spatially confined area. The capability according to the invention to allow liquids to be applied locally and to be illuminated selectively at the same point thus allows light-driven chemical synthesis of molecules to be carried out on a locally isolated basis and in a manner which saves both material and time.

The supply of liquid to the apparatus according to the invention in its refinement as a “printing head” may be provided, for example, via a bundle of glass capillaries. Mechanically robust contact can be achieved by fusing the capillaries to the printing head. The process of a droplet tearing off from the rim of the pipette can be initiated, in particular, by: (a) application of an increased pressure to the printing head; (b) application of a vacuum in a substrate to be printed on; (c) the effect of the force of gravity on the liquid droplets; (d) the use of the piezoelectric effect; (e) an electrical voltage difference between the droplets and the substrate (electrostatic interaction); (f) application of electric current (electrophoretic or electroosmotic); and/or (g) mechanical contact by touching with a suitable wetting capability of the substrate.

Porous substrates of all types, in particular porous silicon, aluminum oxide, silicates and porous organic materials such as nitrocellulose are suitable as substrates that can be printed on for the “printing head” according to the invention. As the pipette and pore sizes decrease, the capillary forces on liquids that are in contact with a porous surface increase. The dispensing of the volume of liquid from the printing head is made easier by the capillary effect of the substrate.

While the invention has been described in detail with particular reference to certain embodiments thereof, the invention is capable of other and different embodiments, and its details are capable of modifications in various obvious respects. As would be readily apparent to those skilled in the art, variations and modifications can be affected while remaining within the spirit and scope of the invention. Accordingly, the foregoing disclosure, description, and drawing figures are for illustrative purposes only, and do not in any way limit the invention, which is defined only by the claims.

1. An apparatus, in which at least one pipette in the form of a through-hole with a predetermined diameter is formed in a substrate, with a rim of the through-hole projecting by a predetermined amount from an adjacent surface of the substrate.

2. The apparatus as claimed in claim 1, wherein at least the rim is composed of at least one different material from the substrate, and is preferably composed of SiO₂ or Si₃N₄.

3. The apparatus as claimed in claim 1, wherein an inner wall of the through-hole is composed at least partially of a different material from the substrate, and is preferably composed of SiO₂ or Si₃N₄.

4. The apparatus as claimed in claim 1, wherein an inner face of the rim and, preferably, an inner wall of the through-hole are composed of a different material from an outer face of the rim.

5. The apparatus as claimed in claim 1, wherein at least one layer composed of an electrically conductive material is formed on the rim and/or on an inner wall of the through-hole.

6. The apparatus as claimed in claim 1, wherein a distal end of the rim is rounded.

7. The apparatus as claimed in claim 1, wherein the through-hole narrows or widens toward a distal end of the rim.

8. The apparatus as claimed in claim 1, wherein the substrate is composed of silicon.

9. The apparatus as claimed in claim 1, wherein two or more pipettes are formed in the substrate and are preferably arranged in a form of a grid in the substrate.

10. A method for forming at least one pipette in a substrate, comprising the steps of:
forming at least one hole in the substrate;
forming at least one changed surface layer on at least an inner surface of the hole; and
selectively removing the substrate, with portions of the changed surface layer essentially not being removed such that the changed surface layer projects above a surface of the substrate and forms a projecting rim.

11. The method as claimed in claim 10, wherein the hole tapers towards a face on which the rim is formed.

12. The method as claimed in claim 10, wherein the hole is initially in a form of a blind hole.

13. The method as claimed in claim 12, wherein once the blind hole has been formed, that face of the substrate which is opposite an opening of the blind hole is removed as far as the base of the blind hole, so that the blind hole is opened in order to form a through-hole.

14. The method as claimed in claim 12, wherein the blind hole tapers toward its base.

15. The method as claimed in claim 12, wherein the blind hole is formed by etching.

16. The method as claimed in claim 13, wherein the face of the substrate which is opposite the opening of the blind hole is removed by chemical and/or mechanical erosion.

17. The method as claimed in claim 10, wherein after the selective erosion, edges of the projecting rim are rounded.

18. The method as claimed in claim 10, wherein the changed surface layer is additionally formed on a surface of the substrate.

19. The method as claimed in claim 10, wherein the changed surface layer is formed over the entire surface of the substrate, and is preferably chemically and/or mechanically removed, before the selective erosion process, on the face of the substrate on which the rim is formed.

20. The method as claimed in claim 19, wherein the selective removal of the substrate is carried out by etching, using an etching agent which essentially does not attack the changed surface layer.

21. The method as claimed in claim 10, wherein the substrate is composed of silicon.

22. The method as claimed in claim 10, wherein at least the changed surface layer is created by coating and/or modification of the surface of the substrate by oxidation or nitriding.

23. The method as claimed in claim 10, wherein the changed surface layer has two or more layers, composed of different materials, at least in the area of the hole.

24. An apparatus comprising:
a substrate;
at least one pipette, which is in a form of a through-hole with a predetermined diameter, formed in the substrate;
wherein a rim of the through-hole projects by a predetermined amount from an adjacent surface of the substrate.
